(19) United States
(12) Patent Application Publication
(10) Pub. No.: US 2023/0221694 A1
(43) Pub. Date: Jul. 13, 2023

(54) METHOD AND COMPUTING SYSTEM FOR PERFORMING A PROGNOSTIC HEALTH ANALYSIS FOR AN ASSET

(71) Applicant: Hitachi Energy Switzerland AG, Baden (CH)

(72) Inventors: Pawel STANO, Chotomów (PL); Frank KIRSCHNICK, Adliswil (CH)

(21) Appl. No.: 18/009,140

(22) PCT Filed: Jun. 7, 2021
(86) PCT No.: PCT/EP2021/065171

§ 371 Date: Dec. 8, 2022

(30) Foreign Application Priority Data
Jun. 8, 2020 (EP) 20178841.1

(51) Int. Cl. G05B 19/042

(52) U.S. Cl. CPC G05B 19/0428; G05B 2219/2639

(57) ABSTRACT

To perform a prognostic health analysis for an asset (11-13), a stochastic simulation is performed. Transition probabilities for transitions between states of a discrete state model (41-44) used in the stochastic simulation are updated as information on asset degradation becomes available.

### CROSS-REFERENCE TO RELATED APPLICATIONS

The present application is a national stage entry of International Patent App. No. PCT/EP2021/065171, filed on Jun. 7, 2021, which claims priority to European Patent App. No. 20178841.1, filed on Jun. 8, 2020, which are both hereby incorporated herein by reference in their entireties.

### FIELD OF THE INVENTION

The present disclosure relates to techniques for assessing a health of an asset. The present disclosure relates in particular to methods and devices for the prognostic assessment of asset health.

### BACKGROUND OF THE INVENTION

Electric power systems, such as power generation, transmission and/or distribution system, and industrial systems include assets. Transformers, power generators, and distributed energy resource (DER) units are examples for such assets. The assets are subject to degradation during operation. For planning purposes, scheduling maintenance or replacement work, it is desirable to estimate the remaining useful life (RUL) of assets.

Simulation techniques can be used to simulate the time evolution of an asset. The parameters of such simulation techniques can be based on historical sensor data captured for a fleet of assets. The simulations provide a good picture for the overall statistical evolution of assets. When a large number of identical or similar assets is operated, new information on the degradation process of the assets may be a valuable source of information. It would be desirable to use information that becomes available during operation of a set of assets in the assessment of the health of the assets.

U.S. Pat. No. 7,788,205 B2 discloses techniques that employ stochastic models that predict the probabilities of state transitions for components in a complex system. The models are trained using output observations from the system at runtime. The overall state and health of the system can be determined at runtime by analyzing the distribution of current component states among the possible states.

Sang-ri Yi et al., “Particle Filter Based Monitoring and Prediction of Spatiotemporal Corrosion Using Successive Measurements of Structural Responses,” SENSORS, vol. 18, no. 11, 13 Nov. 2018 (2018-11-13), page 3909, discloses techniques for prediction of deterioration of a reinforcement bar.

X. Si et al., “A General Stochastic Degradation Modeling Approach for Prognostics of Degrading Systems With Surviving and Uncertain Measurements”, IEEE TRANSACTIONS ON RELIABILITY, IEEE SERVICE CENTER, PISCATAWAY, N.J., US, vol. 68, no. 3, 1 Sep. 2019, pages 1080-1100, discloses a technique for estimating a remaining useful life (RUL). A maximum likelihood estimation framework is provided to determine model parameters based on an expectation maximization algorithm together with particle filtering and smoothing methods.

J. Z. Sikorska et al., “Prognostic modelling options for remaining useful life estimation by industry”, MECHANICAL SYSTEMS AND SIGNAL PROCESSING, vol. 25, no. 5, 1 Jul. 2011, pages 1803-1836 discusses strengths and weaknesses of the main prognostics model classes.

### SUMMARY

There is a need for enhanced techniques of predicting the evolution of asset degradation. There is in particular a need for techniques that allow the prognostic predictions to be made for a degradation of a health of an asset, while allowing the prognostic predictions to be adjusted when new information becomes available from a set of assets. Alternatively or additionally, there is a need for techniques that can combine additional information on the degradation process acquired for several assets of a set of assets, while allowing the health assessment to be performed using a decentralized system.

According to embodiments, methods and computing systems as recited in the independent claims are provided. The dependent claims define preferred embodiments.

According to embodiments, a set of plural agents is used for performing prognostic asset health analysis. Each of the plural agents is associated with one asset of a set of assets and is operative to perform a prognostic health analysis for that asset with which the agent is associated.

Each agent may perform a stochastic simulation, in particular a Markov Chain Monte Carlo (MCMC) method, to obtain a prognosis for an evolution of the asset with which the respective agent is associated. The stochastic simulation may be performed using a discrete state space and transition probabilities.

As new information becomes available, each agent may be operative to update the transition probability used for its respective simulation. This may be done in various ways. For illustration, an agent may receive sensor data indicative of the degradation of the asset for which the agent determines a prognosis for a future evolution of an asset health state. Based on the sensor data, the agent may determine updated transition probabilities for future use in the stochastic simulation.

Alternatively or additionally, an agent may receive information on updated transition probabilities and/or an updated Bayesian probability table as determined by other agents in the set, based on an observed degradation of one or several other assets. Based on the received information on updated transition probabilities and/or an updated Bayesian probability table as determined by other agents in the set, the agent may determine updated transition probabilities for future use in the stochastic simulation.

Alternatively or additionally, an agent may receive information on updated transition probabilities and/or an updated Bayesian probability table as determined by a central module, based on an observed degradation of one or several other assets. Based on the received information on updated transition probabilities and/or an updated Bayesian probability table as determined by the central module, the agent may determine updated transition probabilities for future use in the stochastic simulation.

According to an embodiment, a method of performing a prognostic health analysis for an asset is provided. The asset is included in a set of plural assets that are associated with a set of agents. Each of the agents performs a prognostic health analysis for an associated asset of the set of assets. The method comprises determining, by an agent of the set of agents, a prognosis for a future evolution of an asset health state of an asset of the set of assets by performing a stochastic simulation, the stochastic simulation being performed using transition probabilities for transitions between states of a discrete state model. The method comprises receiving, by the agent, observation information that is a function of an observed degradation of at least one asset of the set of assets. The method comprises updating, by the agent, the prognosis, including updating the transition probabilities based on the received observation information. The method comprises generating output based on a result of the stochastic simulation.

The agent may be operative to update the transition probabilities at a time that may be independent of a time at which other agents update transition probabilities used by the other agents to perform stochastic simulations.

Updating the transition probabilities may be triggered by receipt of the observation information.

Updating the transition probabilities may be an event-driven process.

The observation information may be received from another agent and/or from a central module via a communication channel.

The communication channel may be established only intermittently in communication time intervals.

The observation information may be received in one of the communication time intervals in which the communication channel is established.

The communication time intervals may be predetermined time intervals.

The method may further comprise determining, by a second agent of the set of agents, a second prognosis for a future evolution of an asset health state of a second asset of the set of assets by performing a second stochastic simulation, the stochastic simulation being performed using second transition probabilities for transitions between states of the discrete state model.

The agent and the second agent may use the same discrete state model.

The method may comprise updating, by the second agent, the second prognosis, including updating the second transition probabilities.

The agent may share information on the updated transition probabilities with other agents of the set of agents in an asynchronous manner.

The observation information may be a function of sensor measurements obtained for the asset with which the agent is associated.

The sensor measurements may comprise measurements of one or several industrial asset condition parameters, such as of power system asset condition parameters.

The sensor measurements may comprise measurements of one or several industrial asset operating parameters, such as of power system asset operating parameters.

The sensor measurements may comprise measurements of one or several industrial asset operating parameters, such as of power system asset operating parameters.

The sensor measurements may comprise measurements of one, several, or all of:
temperature parameters;
vibration parameters;
sound and/or ultrasonic parameters;
lubrication parameters;
speed parameters;
flow parameters;
pressure parameters;
gas parameters;
water chemistry parameters;
dissolved gas and/or furanic parameters
electrical parameters (including but not limited to voltage, current signature, and resistance);
derivative parameters that are processed from raw sensor data, including but not limited to derivative parameters computed from any one or any combination of the measurements mentioned above.

The agent and the second agent may use transition probabilities that may initially be the same, but which are updated at different times and/or in different ways. Thus, as time passes during ongoing operation of the asset and the second asset, the transition probabilities used by the agent and the second transition probabilities used by the second agent for performing stochastic simulations may deviate from each other.

The method may further comprise outputting, by the agent, the observation information or data derived therefrom to at least one other agent of the set of agents and/or to a central module.

Outputting the observation information or data derived therefrom to at least one other agent of the set of agents and/or to a central module may be performed in response to a trigger event, such as receipt of the observation information.

A communication channel between the agent and the at least one other agent and/or the central module may be selectively established in an intermittent manner.

Outputting the observation information or data derived therefrom to at least one other agent of the set of agents and/or to a central module may be performed selectively only when the communication channel is available.

The data derived from the observation information may be the updated transition probabilities and/or an updated Bayesian probability table.

The observation information may be a function of sensor measurements obtained for at least one other asset different from the asset with which the agent is associated.

The sensor measurements may comprise measurements of one or several industrial asset condition parameters for the at least one other asset, such as of power system asset condition parameters; of one or several industrial asset operating parameters for the at least one other asset, such as of power system asset operating parameters; and/or of one or several industrial asset operating parameters for the at least one other asset, such as of power system asset operating parameters. The sensor measurements may comprise any of the measurements mentioned above in association with sensor measurements obtained from the asset with which the agent is associated (it being understood that the sensor measurements may also be obtained for at least one other asset different from the asset with which the agent is associated).

The observation information may comprise modified transition probabilities and/or modified Bayesian conditional probabilities.

The modified transition probabilities and/or modified Bayesian conditional probabilities may be received from a central module that receives and combines information on updated transition probabilities determined by two or more agents of the set of agents.

The discrete state space may have n states, with n being an integer greater than two.

Transitions between the states may be governed by a transition matrix.

The transition matrix may be sparsely encoded.

The transition matrix used in the stochastic simulation may have only n−1 non-zero off-diagonal matrix elements.

The observation information may consist of n−1 transition probabilities.

The discrete state space may comprise at least one state in which operation of the asset may be not adversely affected by a failure.

The discrete state space may comprise at least one state in which operation of the asset may be adversely affected by a failure, but the asset continues to operate;

The discrete state space may comprise a state in which the asset may be inoperative due to a failure.

The stochastic simulation may be a Markov Chain Montel Carlo, MCMC, simulation.

The Markov Chain may have order 1, i.e., transitions may be dependent on the state in which the Markov Chain model is currently, while being independent of previous transitions to that state.

The Markov Chain model may be such that states have qualitative interpretation that is monotonically ordered, i.e., it is always possible to compare two states in terms of severity of degradation.

Each state of the discrete state space may have a non-zero transition probability to at most one other state of the discrete state space, which describes more severe degradation, and non-zero transition probability to itself.

The Markov Chain model may be such that states of the discrete state space that do not correspond to failure of the asset have a non-zero transition probability to just one other state of the discrete state space.

The Markov Chain model may be such that a state of the discrete state space that corresponds to failure of the asset does not have any non-zero transition probability to a state other than itself.

Each of the set of agents may perform a stochastic simulation to determine a prognosis for a future evolution of an asset health state of the asset associated with the respective agent.

The agents of the set of agents may be operative to independently update the transition probabilities used in the stochastic simulations.

The method may further comprise receiving, by a central module, information on the transition probabilities updated by the agent.

The central module may determine modified transition probabilities based on the received information.

The central module may output the modified transition probabilities to the set of agents.

Determining the modified transition probabilities may comprise weighting received information with a weighting factor.

The weighting factor may be dependent on an importance associated with the updated transition probabilities determined by the agent.

All assets of the set of assets may be of the same or similar asset type.

All assets of the set of assets may be industrial assets or electric power system assets.

All assets of the set of assets a distributed energy resource (DER) unit, a power generator, a power transformer, or a distribution transformer.

The generated output may be a remaining useful life (RUL) curve, a probability of failure (PoF) curve, or other information representing the degradation of the asset.

The generated output may be a control signal used to control the asset with which the agent is associated.

The generated output may be a control signal used for scheduling a down-time of the asset based on the stochastic simulation, for scheduling maintenance, inspection or replacement work based on the stochastic simulation, and/or for changing maintenance or inspection intervals based on the stochastic simulation.

The generated output may be dependent on the stochastic simulation with the transition probabilities updated by the agent.

The method may comprise outputting the output via a human machine interface (HMI) or a control command interface.

A method of operating and/or maintaining an asset comprises performing a prognostic asset health analysis for each asset of the set of assets using the method according to an embodiment and automatically taking a control or output action based on the prognostic asset health analysis.

The control or output action may comprise performing at least one of the following: generating an alarm or warning based on the computed prognostic asset health state evolution; generating a control signal to control operation of the asset based on the computed prognostic asset health state evolution; scheduling a down-time of the asset based on the computed evolution of the asset health state; scheduling maintenance or inspection work based on the computed evolution of the asset health state; scheduling replacement work based on the computed evolution of the asset health state; changing maintenance or inspection intervals based on the computed evolution of the asset health state.

The control or output action may comprise outputting information on a failure probability as a function of operating time, on a scheduled or rescheduled maintenance work interval, or on a scheduled replacement work interval via an interface.

According to an embodiment, a computing system operative to perform a prognostic health analysis for an asset included in a set of assets is provided. The computing system comprises at least one integrated circuit operative to execute an agent to determine a prognosis for a future evolution of an asset health state of the asset by performing a stochastic simulation, the stochastic simulation being performed using transition probabilities for transitions between states of a discrete state model, receive observation information that may be based on an observed degradation of at least one asset of the set of assets, update the prognosis, including updating the transition probabilities based on the received observation information, and generate output based on a result of the stochastic simulation.

The computing system may be operative such that the agent may be operative to update the transition probabilities at a time that may be independent of a time at which other agents update transition probabilities used by the other agents to perform stochastic simulations.

The computing system may be operative such that updating the transition probabilities may be triggered by receipt of the observation information.

The computing system may be operative such that updating the transition probabilities may be an event-driven process.

The computing system may be operative such that the observation information may be received from another agent and/or from a central module via a communication channel. The computing system may be operative such that the communication channel may be established only intermittently in communication time intervals.

The computing system may be operative such that the observation information may be received in one of the communication time intervals in which the communication channel is established.

The computing system may be operative such that the communication time intervals may be predetermined time intervals.

The computing system may be operative to execute a second agent to determine a second prognosis for a future evolution of an asset health state of a second asset of the set of assets by performing a second stochastic simulation, the stochastic simulation being performed using second transition probabilities for transitions between states of the discrete state model.

The computing system may be operative such that the agent and the second agent may use the same discrete state model.

The computing system may be operative such that the second agent updates the second prognosis, including updating the second transition probabilities.

The computing system may be operative such that the agent may share information on the updated transition probabilities with other agents of the set of agents in an asynchronous manner.

The computing system may be operative such that the observation information may be a function of sensor measurements obtained for the asset with which the agent is associated.

The sensor measurement may comprise measurements of one or several industrial asset condition parameters, such as of power system asset condition parameters.

The sensor measurement may comprise measurements of one or several industrial asset operating parameters, such as of power system asset operating parameters.

The sensor measurement may comprise measurements of one or several industrial asset operating parameters, such as of power system asset operating parameters.

The sensor measurement may comprise measurements of one, several, or all of:
temperature parameters;
vibration parameters;
sound and/or ultrasonic parameters;
lubrication parameters;
speed parameters;
flow parameters;
pressure parameters;
gas parameters;
water chemistry parameters;
dissolved gas and/or furanic parameters
electrical parameters (including but not limited to voltage, current signature, and resistance);

derivative parameters that are processed from raw sensor data, including but not limited to derivative parameters computed from any one or any combination of the measurements mentioned above.

The computing system may be operative such that the agent and the second agent may use transition probabilities that may initially be the same, but which are updated at different times and/or in different ways. Thus, as time passes during ongoing operation of the asset and the second asset, the transition probabilities used by the agent and the second transition probabilities used by the second agent for performing stochastic simulations may deviate from each other.

The computing system may be operative such that the agent may output the observation information or data derived therefrom to at least one other agent of the set of agents and/or to a central module.

The computing system may be operative such that the agent outputs the observation information or data derived therefrom to at least one other agent of the set of agents and/or to a central module in response to a trigger event, such as receipt of the observation information.

The computing system may be operative such that a communication channel between the agent and the at least one other agent and/or the central module may be selectively established in an intermittent manner.

The computing system may be operative such that the agent outputs the observation information or data derived therefrom to at least one other agent of the set of agents and/or to a central module selectively only when the communication channel is available.

The computing system may be operative such that the data derived from the observation information may be the updated transition probabilities and/or an updated Bayesian probability table.

The computing system may be operative such that the observation information may be a function of sensor measurements obtained for at least one other asset different from the asset with which the agent is associated.

The sensor measurements may comprise measurements of one or several industrial asset condition parameters for the at least one other asset, such as of power system asset condition parameters; of one or several industrial asset operating parameters for the at least one other asset, such as of power system asset operating parameters; and/or of one or several industrial asset operating parameters for the at least one other asset, such as of power system asset operating parameters. The sensor measurements may comprise any of the measurements mentioned above in association with sensor measurements obtained from the asset with which the agent is associated (it being understood that the sensor measurements may also be obtained for at least one other asset different from the asset with which the agent is associated). The computing system may be operative such that the observation information may comprise modified transition probabilities and/or modified Bayesian conditional probabilities.

The computing system may be operative such that the modified transition probabilities and/or modified Bayesian conditional probabilities may be received from a central module that receives and combines information on updated transition probabilities determined by two or more agents of the set of agents.

The computing system may be operative such that the discrete state space may have n states, with n being an integer greater than two.

The computing system may be operative such that the computing system may be operative such that transitions between the states may be governed by a transition matrix.

The computing system may be operative such that the transition matrix may be sparsely encoded.

The computing system may be operative such that the transition matrix used in the stochastic simulation may have only n−1 non-zero off-diagonal matrix elements.

The computing system may be operative such that the observation information may consist of n−1 transition probabilities.

The computing system may be operative such that the discrete state space may comprise at least one state in which operation of the asset may be not adversely affected by a failure.

The computing system may be operative such that the discrete state space may comprise at least one state in which operation of the asset may be adversely affected by a failure, but the asset continues to operate.

The computing system may be operative such that the discrete state space may comprise a state in which the asset may be inoperative due to a failure.

The computing system may be operative such that the stochastic simulation may be a Markov Chain Montel Carlo, MCMC, simulation.

The computing system may be operative such that the Markov Chain may have order 1, i.e., transitions may be dependent on the state in which the Markov Chain model is currently, while being independent of previous transitions to that state.

The computing system may be operative such that the Markov Chain model may be such that states have qualitative interpretation that is monotonically ordered, i.e., it is always possible to compare two states in terms of severity of degradation.

The computing system may be operative such that each state of the discrete state space may have a non-zero transition probability to at most one other state of the discrete state space, which describes more severe degradation, and non-zero transition probability to itself.

The computing system may be operative such that the Markov Chain model may be such that states of the discrete state space that do not correspond to failure of the asset have a non-zero transition probability to just one other state of the discrete state space.

The computing system may be operative such that the Markov Chain model may be such that a state of the discrete state space that corresponds to failure of the asset does not have any non-zero transition probability to a state other than itself.

The computing system may be operative to execute a set of agents.

The computing system may be operative such that each agent of the set of agents may perform a stochastic simulation to determine a prognosis for a future evolution of an asset health state of the asset associated with the respective agent.

The computing system may be operative such that the agents of the set of agents may be operative to independently update the transition probabilities used in the stochastic simulations.

The computing system may be operative to execute a central module to receive information on the transition probabilities updated by the agent.

The computing system may be operative such that the central module may determine modified transition probabilities based on the received information.

The computing system may be operative such that the central module may output the modified transition probabilities to the set of agents.

The computing system may be operative such that the central module weighs received information with a weighting factor top determine the modified transition probabilities.

The computing system may be operative such that the weighting factor may be dependent on an importance associated with the updated transition probabilities determined by the agent.

The computing system may be operative to execute a set of agents to perform a prognostic health analysis for a set of assets, wherein all assets of the set of assets may be of the same or similar asset type.

The computing system may be operative to execute a set of agents to perform a prognostic health analysis for a set of assets, wherein all assets of the set of assets may be industrial assets or electric power system assets.

The computing system may be operative to execute a set of agents to perform a prognostic health analysis for a set of assets, wherein all assets of the set of assets a distributed energy resource (DER) unit, a power generator, a power transformer, or a distribution transformer.

The computing system may be operative such that the generated output may be a remaining useful life (RUL) curve, a probability of failure (PoF) curve, or other information representing the degradation of the asset.

The computing system may be operative such that the generated output may be a control signal used to control the asset with which the agent is associated.

The computing system may be operative such that the generated output may be a control signal used for scheduling a down-time of the asset based on the stochastic simulation, for scheduling maintenance, inspection or replacement work based on the stochastic simulation, and/or for changing maintenance or inspection intervals based on the stochastic simulation.

The computing system may be operative such that the generated output may be dependent on the stochastic simulation with the transition probabilities updated by the agent.

The computing system may be operative to output the output via a human machine interface (HMI) or a control command interface.

The computing system may be operative to operate and/or control a set of assets, with the computing system being operative to perform a prognostic asset health analysis for each asset of the set of assets and automatically take a control or output action based on the prognostic asset health analysis.

The computing system may be operative such that the control or output action may comprise performing at least one of the following: generating an alarm or warning based on the computed prognostic asset health state evolution; generating a control signal to control operation of the asset based on the computed prognostic asset health state evolution; scheduling a down-time of the asset based on the computed evolution of the asset health state; scheduling maintenance or inspection work based on the computed evolution of the asset health state; scheduling replacement work based on the computed evolution of the asset health state; changing maintenance or inspection intervals based on the computed evolution of the asset health state.

The computing system may be operative such that the control or output action may comprise outputting information on a failure probability as a function of operating time, on a scheduled or rescheduled maintenance work interval, or on a scheduled replacement work interval via an interface.

An industrial or electric power system according to an embodiment comprises a set of assets and the computing system to perform a prognostic asset health analysis for the assets.

The computing system may be a decentralized control system of the industrial or power system.

Various effects and advantages are associated with embodiments. The stochastic simulation executed by an agent to obtain a prognosis for the future evolution of an asset health state may be updated using dynamically arriving data from comparable industrial or power system assets (e.g., a learning curve for a green field project).

Information between agents responsible for performing the asset health state analysis for several comparable industrial assets can be efficiently transferred. Information may be shared between the agents, thereby providing fleet learning, even when the agents associated with different assets operate as semi-independent agents.

The information between agents responsible for different assets may be shared in a compressed form without the need for storing and sending full data. For illustration, it may be sufficient to store and send only non-zero matrix elements of transition matrices, optionally with information indicating the relative importance.

When using a discrete state space and non-zero transition probabilities to at most one other state of the discrete state space that corresponds to the next degree of severity of degradation, only a small number of parameters is required for sharing information on updated transition probabilities between agents and/or between agents and the central module.

Additional information can be generated, such as quantitative information on a variance or confidence interval of a RUL or PoF curve, which can be used in prescriptive tools or applications.

### BRIEF DESCRIPTION OF THE DRAWINGS

The subject-matter of the present disclosure will be explained in more detail with reference to preferred exemplary embodiments which are illustrated in the attached drawings, in which:

FIG. 1 is a schematic view of a power system having a computing system according to an embodiment.

FIG. 2 is a schematic view of a power system having a computing system according to an embodiment.

FIG. 3 is a diagram representing a Markov Chain model employed in embodiments.

FIG. 4 is a block diagram showing agents according to an embodiment.

FIG. 5 is a block diagram showing agents and a central module according to an embodiment.

FIG. 6 is a flow chart of a method according to an embodiment.

FIG. 7 is a graph illustrating operation of a method and computing system according to an embodiment.

FIG. 8 are bar diagrams illustrating a time evolution of state occupation probabilities.

FIG. 9 is a graph illustrating exemplary output generated by a method and computing system according to an embodiment.

FIG. 10 is diagram illustrating operation of a method and system according to an embodiment.

FIG. 11 is diagram illustrating operation of a method and system according to an embodiment.

FIG. 12 is a block diagram of a computing system according to an embodiment.

FIG. 13 is a block diagram of a computing system according to an embodiment.

### DETAILED DESCRIPTION OF EMBODIMENTS

Exemplary embodiments will be described with reference to the drawings in which identical or similar reference signs designate identical or similar elements. While some embodiments will be described in the context of assets of a power system, such as distributed energy resource (DER) units or transformers, the embodiments are not limited thereto. The features of embodiments may be combined with each other, unless specifically noted otherwise.

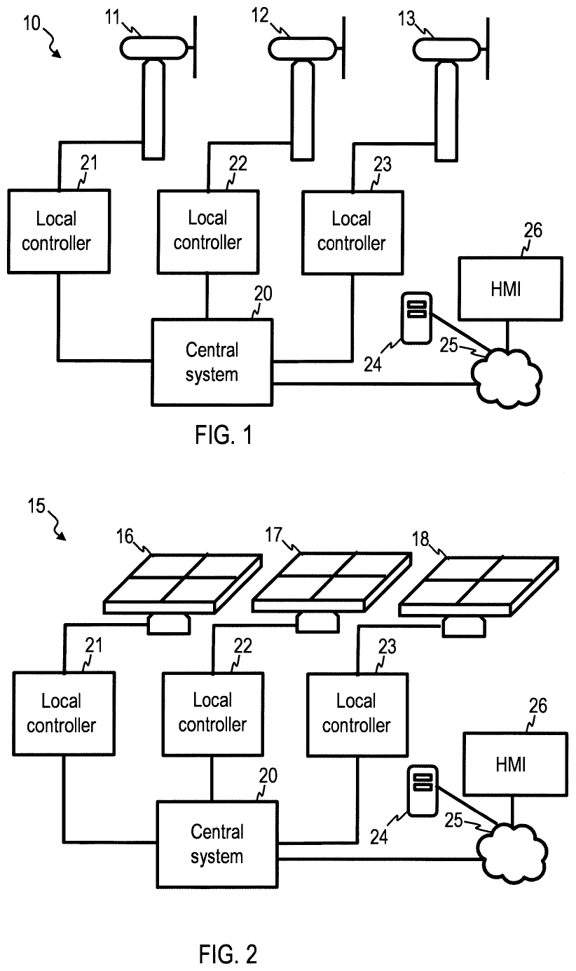

FIGS. 1 and 2 are schematic views of a power system 10, 15. The power systems 10, 15 comprise a plurality of assets. The assets may include generators, such as distributed energy resource (DER) units 11-13, 16-18, transformers, or other electric power system assets.

The power system 10, 15 includes a control system comprising local controllers 21-23, each associated with an asset. The control system may include a central system 20. The central system 20 may be communicatively coupled with the local controllers. The central system 20 may be communicatively coupled with a remote (e.g., cloud-based) server system 24.

As will be described in more detail below, the local controllers 21-23, the central system 20, and/or the remote server system 24 may be operative to perform a prognostic asset health analysis, using a discrete state model. The discrete state model may be a Markov Chain model. The discrete model may have a specific configuration, as will be explained below.

Plural agents may be deployed, each associated with and responsible for performing the prognostic asset health analysis for one of the assets. Each agent may be operative to locally update transition probabilities between states of a discrete state model (such as a Markov Chain model). This may be done in an event-driven way or in a time-driven way. The updates for the transition probabilities may be dependent on one or several of:
sensor data for the asset for which the agent determines a prognosis for a future evolution of the asset health state;
transition probabilities determined by another agent for another asset of the same or similar asset type;
transition probabilities determined by a central module that can at least intermittently communicate with the agents.

The agents may also be referred to as “local agents”. Updates of transition probabilities performed locally by the agents using information captured for the associated asset may also be referred to as “local updates”.

The agents may, but do not need to be executed on the local controllers 21-23. The central module may be executed on the central system 20 and/or the remote sever system 24, without being limited thereto.

The agents executed on one or several of the local controllers 21-23, the central system 20, and/or the remote server system 24 may be operative to perform a stochastic simulation that includes a plurality of independent simulations, in particular a Markov Chain Monte Carlo (MCMC) simulation, to perform the prognostic asset health analysis.

Results of the prognostic asset health analysis may be used by the local controllers 21-23, the central system 20, and/or the remote server system 24 for scheduling down-times, maintenance work, replacement work or for automatically performing control operations. The local controllers 21-23, the central system 20, and/or the remote server system 24 may be operative to generate and output control or output data. Output may be provided via a human machine interface (HMI) 26. The HMI may be coupled to the local controllers 21-23, the central system 20, and/or the remote server system 24 via the internet or another wide area network (WAN).

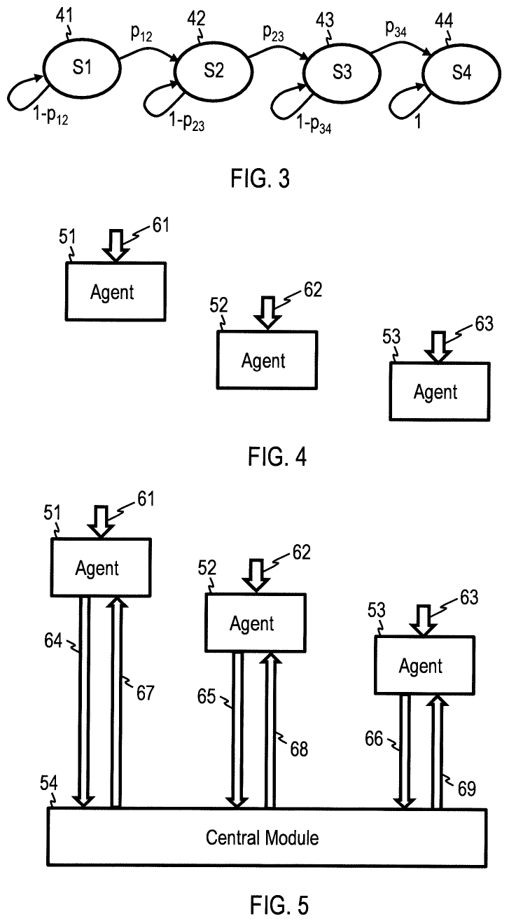

As will be explained in more detail with reference to FIG. 3 to FIG. 12, the prognostic asset health analysis may involve simulating time-evolution of an asset.

The techniques described herein may be used when no sensor data are available for a specific asset for which the prognostic asset health analysis is performed by an agent. For illustration, a remaining useful life (RUL) curve or other prognostic asset health prediction may be computed for an asset, such as asset 11, 16, even when no sensor data is (yet) available for that asset 11, 16. Information on a degradation of similar or identical assets 12, 13, 17, 18 detected during life operation of the asset 11, 16 may be used to dynamically update transition probabilities used in a stochastic simulation.

Fleet learning may thus be implemented, that allows information to be used for updating the prognosis for future evolution of asset health states of a set of assets 11-13, 16-18, using a set of agents, which can take advantage of information on degradation as it becomes dynamically available during operation.

In order to reduce the amount of data that needs to be exchanged between the agents and/or between the agents and the central module, a specific discrete state model with a set of discrete states and specifically designed transition probabilities may be used.

FIG. 3 is a graph of a Markov Chain model that can be used in methods and computing systems according to embodiments. A state space of the Markov Chain model consists of a set of n states S1, . . . , Sn. In the present case, n=4. However, a state space having a different number of states (e.g., n=3 or n=5 or n>5) may be used instead.

The states of the state space may be ordered in such a manner that a severity of degradation of the asset health increases from S1 to S2, from S2 to S3, etc. I.e., all but the last state of the Markov Chain model may be followed by another state that represents a more severe degradation. The last state of the Markov Chain model may represent the most severe degradation.

The Markov Chain model may be set up in such a way that the 1^{st}, 2^{nd}, . . . (n−1)^{th} state 41-43 have a non-zero transition probability p₁₂, p₂₃, p₃₄ to just one other state of the state space. The n^{th} state 44 does not have a non-zero transition probability to a state other than itself.

For illustration, the Markov Chain model may be such that there is a finite transition probability p₁₂ from the first state 41 to the second state 42, but a zero transition probability from the second state 42 back to the first state 41. With probability 1-p₁₂, the first state 41 is maintained in an iteration of the stochastic simulation.

The Markov Chain model may be such that there is a finite transition probability p₂₃ from the second state 42 to the third state 43, but a zero transition probability from the third state 43 back to the second state 42. With probability 1-p₂₃, the second state 42 is maintained in an iteration of the stochastic simulation.

The Markov Chain model may be such that there is a finite transition probability p₃₄ from the third state 43 to the fourth state 44, but a zero transition probability from the fourth state 44 back to the third state 43. With probability 1-p₃₄, the third state 43 is maintained in an iteration of the stochastic simulation.

The final state 44 of the Markov Chain model may correspond to a state in which the asset has failed to such a degree that it is no longer operative.

The other states 41-43 of the state space may correspond to different degrees of degradation.

For illustration, a first state 41 (which may also be referred to as “unknown” state S1) may correspond to an asset state in which there is no known degradation that would affect asset operation. For illustration, the first state 41 may correspond to a state in which no failures are recorded or in which no failures can be recorded.

A second state 42 (which may also be referred to as “incipient” state S2) may correspond to a detectable failure that are of such minor severity that they do not immediately affect the asset's performance. Such incipient failures are usually characterized by short Mean Time to Repair (MTTR), low repair costs, and low impact on overall performance. If not maintained properly, the incipient failures can evolve into more severe degraded failures.

A third state 43 (which may also be referred to as “degraded” state S3) may correspond to a mode that describes failures that significantly reduce the system's performance but do not lead to immediate asset shutdown. Usually such failures are caused by components deterioration. If left untreated, the degraded will eventually lead to the critical failure.

The fourth state 44 (which may also be referred to as “critical” state S4) may correspond to the most severe failure mode that causes an immediate and complete shutdown of the asset. It is usually characterized by long and costly (due to complete production loss) MTTR.

Initial transition probabilities of the Markov Chain model may be received via a user interface from a human expert or may be determined using historical data. Various sets of transition probabilities p₁₂, p₂₃, p₃₄ may be used. For illustration, N>1, in particular N>2 different sets of transition probabilities p₁₂, p₂₃, p₃₄ may be used to simulate the evolution of the asset health state under different ambient and/or operating conditions.

For a discrete state space having n=4 states that are arranged as explained above (i.e., in an order of increasingly severe degradation from 1 to n), a transition matrix for the model may be defined as

$$T = ( \begin{matrix}1 - {p}_{12} & 0 & 0 & 0 \\ {p}_{12} & 1 - {p}_{23} & 0 & 0 \\ 0 & {p}_{23} & 1 - {p}_{34} & 0 \\ 0 & 0 & {p}_{34} & 1\end{matrix} ) \qquad ( 1 )$$

Generally, for a discrete state space having n states that are arranged as explained above (i.e., in an order of increasingly severe degradation from 1 to n), a transition matrix for the model may be defined as

$$T = ( \begin{matrix}1 - {p}_{12} & 0 & 0 & 0 & 0 \\ {p}_{12} & 1 - {p}_{23} & 0 & 0 & 0 \\ 0 & {p}_{23} & 1 - {p}_{34} & 0 & 0 \\ ⋮ & ⋮ & ⋮ & ⋱ & ⋮ \\ 0 & 0 & 0 & {p}_{n - 1 , n} & 1\end{matrix} ) \qquad ( 2 )$$

The transition matrix T may be a sparse matrix. The transition matrix T may have n−1 non-zero off-diagonal matrix elements only, which are arranged below the diagonal of the matrix. The transition matrix T is fully defined by the n−1 transition probabilities p₁₂, p₂₃, p_{n-1,n}. These n−1 transition probabilities fully define the possible transitions between the different states of the discrete state model.

It will be appreciated that the transition matrix T may be dependent on the asset, even when the dynamics are determined for a set of identical or similar assets. I.e., different agents may use different transition probabilities p₁₂, p₂₃, . . . p_{n-1,n}, at least as the transition probabilities are being updated during operation.

FIG. 4 is a block diagram showing a system according to an embodiment. A set of agents 51, 52, 53 is deployed. Each of the agents 51, 52, 53 is associated with an asset, and is responsible for determining a prognosis for a future evolution of an asset health state for that specific asset.

The agents 51, 52, 53 may be executed on different local controllers 21-23. The agents 51, 52, 53 may be executed on the central system 20 and/or the remote server system 24.

A first agent 51 performs a stochastic simulation (e.g., a MCMC) to simulate a degradation process of a first asset 11, 16. The first agent 51 uses a transition matrix T₁. The transition matrix T₁ may be initialized identically for all agents 51-53. During operation, the first agent 51 may update the transition matrix T₁ in a time-dependent manner.

The first agent 51 may update the transition matrix T₁ in an event-driven manner. For illustration, the transition matrix T₁ may be updated in response to receipt of first observation information 61 and/or in response to the intermittent establishment of a communication channel for receipt of the first observation information 61 via a push or pull mechanism. The first observation information 61 may be or include any one or any combination of the following:
Sensor data for the first asset 11, 16 for which the first agent 51 determines a prognosis for a future evolution of the asset health state.
Transition probabilities p₁₂, p₂₃, . . . p_{n-1,n}, or Bayesian probability table data determined by another agent 52, 53 for another asset 12, 13, 17, 18 of the same or similar asset type as the first asset 11, 16.
Transition probabilities determined by a central module that can at least intermittently communicate with the first agent 51, as will be explained in more detail with reference to FIG. 5.

A second agent 52 performs a stochastic simulation (e.g., a MCMC) to simulate a degradation process of a second asset 12, 17. The second agent 52 uses a transition matrix T₂. The transition matrix T₂ may be initialized identically for all agents 52-53. During operation, the second agent 52 may update the transition matrix T₂ in a time-dependent manner. The transition matrix T₂ may have a time evolution that is different from a time evolution of the transition matrix T₁ used by the first agent 51.

The second agent 52 may update the transition matrix T₂ in an event-driven manner. For illustration, the transition matrix T₂ may be updated in response to receipt of second observation information 62 and/or in response to the intermittent establishment of a communication channel for receipt of the second observation information 62 via a push or pull mechanism. The second observation information 62 may be or include any one or any combination of the following:
Sensor data for the second asset 12, 17 for which the second agent 52 determines a prognosis for a future evolution of the asset health state.
Transition probabilities p₁₂, p₂₃, . . . p_{n-1,n}, or Bayesian probability table data determined by another agent 52, 53 for another asset 11, 13, 16, 18 of the same or similar asset type as the second asset 12, 17.
Transition probabilities determined by a central module that can at least intermittently communicate with the second agent 52, as will be explained in more detail with reference to FIG. 5.

A third agent 53 performs a stochastic simulation (e.g., a MCMC) to simulate a degradation process of a third asset 13, 18. The third agent 53 uses a transition matrix T₃. The transition matrix T₃ may be initialized identically for all agents 53-53. During operation, the third agent 53 may update the transition matrix T₃ in a time-dependent manner. The transition matrix T₃ may have a time evolution that is different from a time evolution of the transition matrix T₁ used by the first agent 51 and/or a time evolution of the transition matrix T₂ used by the second agent 52.

The third agent 53 may update the transition matrix T₃ in an event-driven manner. For illustration, the transition matrix T₃ may be updated in response to receipt of third observation information 63 and/or in response to the intermittent establishment of a communication channel for receipt of the third observation information 63 via a push or pull mechanism. The third observation information 63 may be or include any one or any combination of the following:
Sensor data for the third asset 13, 18 for which the third agent 53 determines a prognosis for a future evolution of the asset health state.
Transition probabilities p₁₂, p₂₃, p_{n-1,n}, or Bayesian probability table data determined by another agent 53, 53 for another asset 11, 12, 16, 17 of the same or similar asset type as the third asset 13, 18.
Transition probabilities determined by a central module that can at least intermittently communicate with the third agent 53, as will be explained in more detail with reference to FIG. 5.

The agents 51-53 may update their transition matrices in an asynchronous manner. The updated transition matrices may be used for the simulation at least from the time of update forward. Optionally, the stochastic simulation may be repeated for the past prior to generation of the updated transition matrices, thereby re-computing the prognosis not only for the future, but also for the past.

The agents 51-53 may provide information on the updated transition matrices to the other agents of the system, either directly or via a central module. With the transition matrices being sparse matrices, only very few parameters (e.g., only n−1 independent transition probabilities p₁₂, p₂₃, . . . p_{n-1,n}) need to be transmitted.

Information on an importance of an update may be computed. The information on the importance may quantify how reliable the agent 51-53 performing the update considers the updated transition probabilities p₁₂, p₂₃, . . . p_{n-1,n} to be.

FIG. 5 is a block diagram showing a system according to an embodiment. A set of agents 51, 52, 53 is deployed. Each of the agents 51, 52, 53 is associated with an asset, and is responsible for determining a prognosis for a future evolution of an asset health state for that specific asset.

The agents 51, 52, 53 may be executed on different local controllers 21-23. The agents 51, 52, 53 may be executed on the central system 20 and/or the remote server system 24.

A central module 54 may be executed on the central system 20 and/or the remote server system 24.

The agents 51, 52, 53 and the central module 54 may be communicatively coupled.

Communication channels between the agents 51, 52, 53 and the central module 54 may, but do not need to be persistent communication channels. The communication channels may be established in an intermittent manner. For illustration, the communication channels may be established in an event-driven or periodic manner.

When the first agent 51 updates transition probabilities used in the stochastic simulation performed by the first agent based on available local information 61, it may provide information 64 on the updated transition probabilities to the central module 54. The central module 54 may process the information 64 and may optionally aggregate it with information on updates of transition probabilities performed by other agents 52, 53. The central module 54 may provide updated, more reliable information on the transition probabilities and/or the Bayesian probabilities used to compute the transition probabilities to the second and third agents 52, 53 as data 68, 69. The data 68, 69 also represents a form of “observation information” in the sense of this application, because it is based on degradation observed during real-life operation of the industrial or electric power system.

When the second agent 52 updates transition probabilities used in the stochastic simulation performed by the second agent based on available local information 62, it may provide information 65 on the updated transition probabilities to the central module 54. The central module 54 may process the information 65 and may optionally aggregate it with information on updates of transition probabilities performed by other agents 51, 53. The central module 54 may provide updated, more reliable information on the transition probabilities and/or the Bayesian probabilities used to compute the transition probabilities to the first and third agents 51, 53 as data 67, 69. As mentioned above, the data 67, 69 represents a form of “observation information” in the sense of this application, because it is based on degradation observed during real-life operation of the industrial or electric power system.

When the third agent 53 updates transition probabilities used in the stochastic simulation performed by the third agent based on available local information 63, it may provide information 66 on the updated transition probabilities to the central module 54. The central module 54 may process the information 65 and may optionally aggregate it with information on updates of transition probabilities performed by other agents 51, 52. The central module 54 may provide updated, more reliable information on the transition probabilities and/or the Bayesian probabilities used to compute the transition probabilities to the first and second agents 51, 52 as data 67, 68. As mentioned above, the data 67, 68 represents a form of “observation information” in the sense of this application, because it is based on degradation observed during real-life operation of the industrial or electric power system.

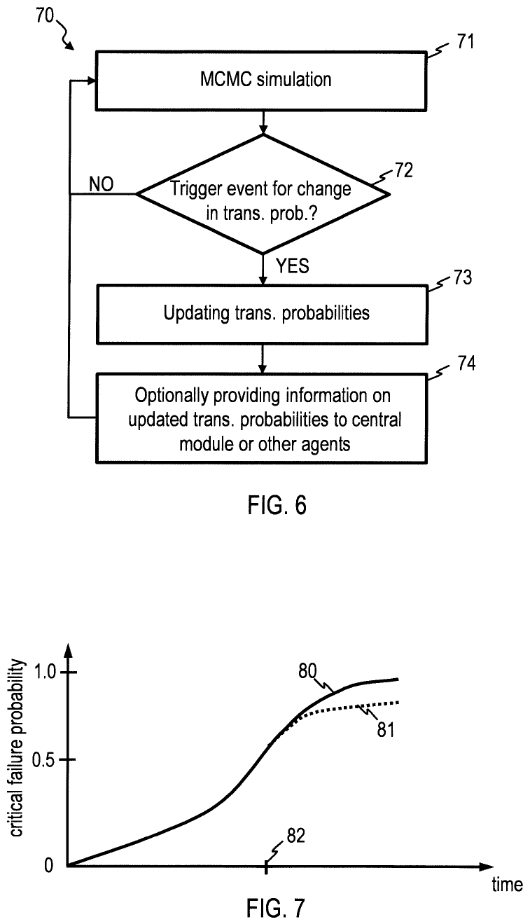

FIG. 6 is a flow chart of a method 70 according to an embodiment. The method 70 may be performed automatically by each one of the agents 51-53 that may be executed by one or several IC(s) in the local controllers 21-23, the central system 20, and/or the remote server system 24. Different agents 51-53 may perform the method 70 independently of each other.

At step 71, MCMC simulations or other stochastic simulations of the Markov Chain model are performed. Step 71 may include performing more than 100, more than 1000, more than 2000, more than 5000 simulations, more than 10000 simulations, more than 50000 simulations, more than 100000 simulations, more than 500000 simulations, or one million or more simulations. With increasing computational power, there is no upper bound for the number of simulations. The simulations may be performed in parallel.

While a large number of simulations (e.g., more than 100 or more than 1000) may be performed for any set of transition probabilities p₁₂, p₂₃, . . . p_{n-1,n} of the Markov Chain model, the transition probabilities need not be the same for all simulations performed by the same agent. Different sets of transition probabilities p₁₂, p₂₃, . . . p_{n-1,n} may be used to quantitatively assess the impact of different operating conditions and/or ambient conditions.

The simulations may be performed over a time horizon. The time horizon may be dependent on the specific asset. For power system assets such as transformers, typical lifetimes are in excess of 10 years, in excess of 20 years, or even longer. Thus, the stochastic simulations may be performed over time horizons that are in excess of 10 years, in excess of 20 years, or even longer. The time horizons may also be shorter, depending on the asset. For illustration, the prognostic time horizon may be 1 week or more, 1 month or more, etc. The prognostic time horizon may be measured in and may include a plurality of cycles, e.g., a certain number of flight cycles, ship route cycles, train route cycles, etc.

An initial state for the simulations may be selected depending on information on the asset is available. If no information on the asset is available, the simulations may all start with the first state 41 in which there is no information on detectable failures. If information on the asset is available, e.g. sensor data collected after installation, this sensor data may be used for initializing the simulations. A distribution of initial states for the various MCMC or other stochastic simulations may be selected depending on whether the already collected sensor data indicates that there is no recognizable failure that affects asset performance or whether there are detectable issues that affect asset performance.

Furthermore, the initialization can be probabilistic. For illustration, if the information available is not conclusive whether the asset is in state 41 or 42 with equal chances to be in either of these states, the system can be initialized with a Bayesian prior distribution such that probability of the asset being in state 41 equals to 50% and probability of the asset being in state 42 equals to 50%. Other probabilistic initiations with more states and different probabilities may also be possible.

At step 72, it is determined whether a trigger event for updating the transition probabilities is fulfilled. The trigger event may be receipt of observation information, which may be based on sensor data captured for the asset during ongoing operation and/or which may depend on observations for other assets of the same or a similar type.

If the trigger event for changing the transition probabilities is not fulfilled, the method may return to step 71. If the trigger event for changing the transition probabilities is not fulfilled, the method may continue at step 73.

At step 73, the transition probabilities may be updated. Updating the transition probabilities may be performed based on an observed degradation dynamic of one or several assets 11-13, 16-18, as compared to the dynamics expected based on the MCMC simulations. Updating the transition probabilities at step 73 may include re-computing the transition probabilities based on Bayesian conditional probabilities, which may be derived from the observed degradation of the assets 11-13, 16-18.

At step 74, information on the updated transition probabilities may be provided to other agents and/or the central module 74. Importance information quantifying the relative importance of the update (e.g., based on the amount of sensor data used in computing the updated transition probabilities) may also be provided to other agents and/or the central module 74 at step 74.

The method may further comprise computing a probability, as a function of time over the time horizon, that the Markov Chain model has evolved into the critical state that corresponds to an inoperative asset. The method may comprise computing a time evolution of a health index that, for any time during the prognostic time horizon, depends on the probabilities for the Markov Chain model to be in the 1^{st}, 2^{nd}, . . . n^{th} state 41-44 of the Markov Chain model. The method may comprise computing a RUL curve, a PoF curve, or another output that indicates a probability of asset failure as a function of operating time.

The method may further comprise generating output. The output may include information on the asset's remaining useful life as a function of time. The output may include information on the asset's probability of failure as a function of time. The output may include control and/or output data that is obtained by further processing of the simulations results, such as a schedule for inspection, maintenance or replacement work on the asset.

FIG. 7 is a schematic view of an output 80 that may be automatically generated and output. The output 80 may indicate the probability that the Markov Chain model has evolved into the critical state that corresponds to an inoperative asset. The output 80 may be determined by computing, for each one of a plurality of times over the time horizon, the fraction of simulations in which the Markov Chain model is in the critical state S4 of the state space.

As illustrated in FIG. 7, the transition probabilities used in the stochastic simulation are updated in response to receipt of more reliable information on the asset degradation at a time 82. At least from time 82 onward, the prognosis for the future evolution of the asset health state is computed using the updated transition probabilities. Optionally, the evolution may also be re-computed for times prior to time 82.

For comparison, FIG. 7 also shows curve 81 that would have been obtained if the transition probabilities had not been updated.

Additional or alternative output may be generated. For illustration, a RUL curve or other information indicative of the asset's degradation may be processed to automatically schedule inspection, maintenance, or replacement work, to output the schedule information to an operator and/or to automatically schedule down-times.

Alternatively or additionally, the RUL curve or other information indicative of the asset's degradation may be processed, using threshold comparisons or other triggers, to determine whether and when alarms, warnings, or other signals are to be output to the operator.

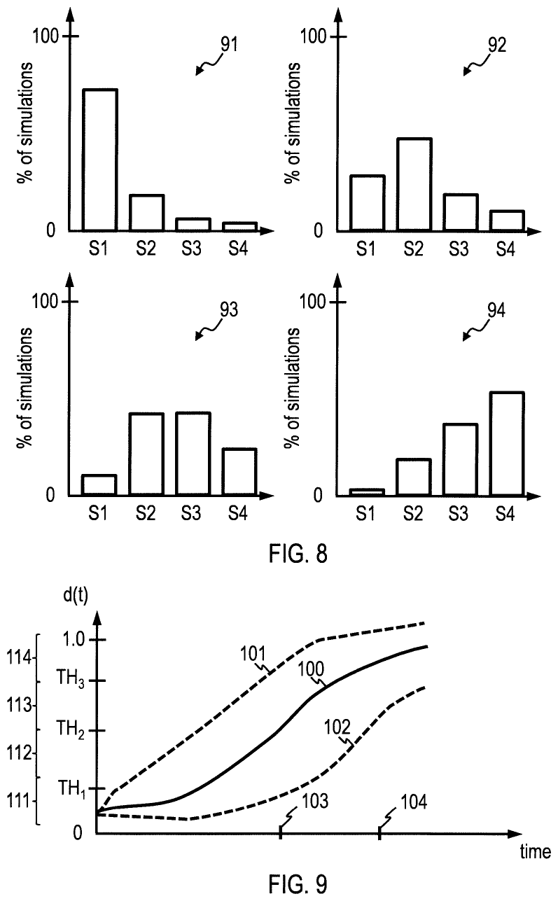

FIG. 8 illustrates the stochastic distribution 81-84 of the population of the various states S1-S4 of the state space of the Markov Chain model. The distribution 81 corresponds to a first time in which most of the Markov Chain model simulations are still in the state S1 that corresponds to an asset with no detectable degradation. The distributions 82, 83 correspond to later second and third times in which the states S2 and S3 that correspond to incipient or more advanced degradation have become more populated. The distribution 84 corresponds to an even later fourth time at which the critical state S4 corresponding to asset shutdown is populated most, reflecting that it is more probable for the asset to be in the inoperative state by that time than in an operative state.

While relevant prognostic asset health predictions may be obtained from the probability for the asset to be in the critical state S4, which is the final state of the Markov Chain model, the output into which the results of the stochastic simulations are processed may depend on all probabilities p₁, p₂, . . . pₙ for the Markov Chain model to be in the respective 1^{st}, 2^{nd}, . . . n^{th} state, as determined by the stochastic simulations.

For illustration, for any time j within the time horizon over which the stochastic simulations are performed, a scalar function

d(j)=Σ_{i=1, . . . ,n}pᵢ(j)×mᵢ (3)

may be computed, where pᵢ(j) designates the probability for the Markov Chain model to be in the i^{th} state at time j, as determined by the stochastic simulations, and where mᵢ denotes a scalar value that is a monotonous, in particular strictly monotonous, function of state label i. For illustration, all mᵢ may be selected from an interval such that mᵢ≤m₂≤ . . . ≤mₙ, in particular such that m₁<m₂< . . . <mₙ.

By outputting the function d(j) or information derived therefrom, a degradation that results in reduced RUL may be reflected more adequately even if it has not yet resulted in the asset reaching the critical state S4.

The function d(j) is indicative of a degradation and can be related to a health index h(j) by h(j)=1−d(j), when d(j) is constrained to take values between 0 and 1.

The function d(j) or health index h(j) may also be used to identify transitions between different states of the discrete state model based on sensor measurements. For illustration, sensor measurements may be processed into a degradation function d(j) or health index h(j). Heuristics may be used for this processing. The value of the degradation function d(j) or health index h(j) may be subject to one or several threshold comparisons to assign an asset state, as observed in a set of sensor measurements, to one of the discrete states S1, . . . , Sn of the discrete state model. Processing the sensor measurements into the degradation function d(j) or health index h(j) may be done in various ways. The scalar function may take sensor measurements captured at various times as inputs and may process them into a scalar function that represents the observed evolution of asset health, as reflected by the health index h or degradation index d.

Various techniques may be used to compute the scalar function that is used to identify transitions between the discrete states. For illustration, sensor measurements may be compared to a range of operation values. For each sensor measurement outside the range, a penalty may be imposed. Weighted summation or other processing that combines products of a weighting factor for a sensor measurement and a value that depends on the deviation of the sensor measurement from the normal operation value range may be used. The weighting factors are dependent on the respective sensor and indicate the importance of the measurement for asset health.

Tools are known that provide a mapping of sensor measurements into a continuous health or degradation functions for a wide variety of assets, including, without limitation, circuit-breakers, batteries (such as Li-ion batteries), or transformers. For illustration, tools such as the Ellipse APM or RelCare tool process sensor measurements to provide a function having a value in a continuous range and indicating the asset health. Normalization may be used to normalize the health or degradation function to a desired range (such as from 0 to 1).

The sensor measurements that are used may comprise one or several industrial asset condition parameters (such as power system asset condition parameters), one or several industrial asset operating parameters (such as power system asset operating parameters)), one or several industrial asset operating parameters (such as power system asset operating parameters).

The form and type of the sensor measurements that are being used may be dependent on the specific asset and/or the implementation of the health or degradation function. Examples for such known techniques are mentioned above.

The continuous health or degradation functions may be or may comprise a condition monitoring function, sometimes also referred to as condition monitoring parameter.

The continuous health or degradation functions may be a derivative function that takes as input arguments raw sensor measurement for a given device (that may be recorded in SCADA system) recorded over certain time window (such as for an hour, a day, a week, etc.). Data processing techniques (such as one or several of: data cleaning, outlier removal, filtering, dimension reduction, correlation analysis, etc.) may be applied to the raw sensor measurement. The processed data may be used to calculate a trend that may give insight about the dynamics of physical processes within the device (such as wearing of, ageing, material degradation, etc.). As disclosed in more detail herein, transition probabilities from one state to another state of a Markov chain may be used in embodiments.

The continuous health or degradation functions may be or may comprise a signature of failure function. The signature of failure function may correlate (i) outputs of condition monitoring functions that takes inputs from one group of sensors with (ii) event logs that may be recorded by another group of sensors, to calculate a conditional probability of a failure for different operational conditions.

The form and type of the sensor measurements that are being used may be dependent on the specific asset and/or the implementation of the health or degradation function. For illustration, tools such as the Ellipse APM or RelCare tool process sensor measurements, and the sensor measurements required for these tools are supplied to the tool.

Merely for illustration and without limitation, the sensor measurements may comprise one, several, or all of:
temperature parameters (that may relate to, e.g., the asset, a component of the asset, a medium processed by the asset, a medium used in the asset (such as a working fluid, cooling fluid, and/or insulation fluid), ambient conditions, etc.)
vibration parameters (that may be in a time domain, frequency ranges, including stress waves, and/or phases); transmission line vibrations or rotary machine vibrations are exemplary for such parameters;
sound and/or ultrasonic parameters;
lubrication parameters (that may include information on a lubricant, such as grease, oil or water; the lubrication parameters may include metallurgy of particles found in the lubricant or filter debris);
speed parameters (such as wind speed, shaft rotation, etc.);
flow parameters (such as flow parameters of a medium that is processed, which may be a gas or liquid; or flow parameters of one or several fluids that are used as a working fluid, cooling fluid, and/or insulation fluid);
pressure parameters (such as hydrostatic, dynamic, and/or total pressure of a medium that is processed, which may be a gas or liquid; or hydrostatic, dynamic, and/or total pressure of one or several fluids that are used as a working fluid, cooling fluid, and/or insulation fluid);
gas parameters (which may be relevant for, e.g., input gas e.g. for biogas facility, process gas and exhaust gas);
water chemistry parameters (which may be relevant for, e.g., boiler tube corrosion);
dissolved gas and/or furanic parameters (e.g., for transformer condition monitoring);
electrical parameters (which may include voltage, current signature, and resistance, without being limited thereto);
calculated parameters (which are also referred to as derivative parameters, engineered features, or virtual sensors) that are functions of the raw sensor data.

The techniques disclosed herein allow any health or degradation function to be mapped to the discrete states of the state model, using optional normalization and a threshold comparison.

In an exemplary implementation, the transition probabilities may be determined based on conditional probabilities. For illustration, the transition probability at a time j for a transition from the i^{th} state to the (i+1)^{th} state (where 1≤i≤n−1) may be determined as

p_{i→i+1}(j)=#(xⱼ₊ᵢ=Sᵢ₊₁∧xⱼ=Sᵢ)/#(xⱼ=Sᵢ). (4)

In Equation (4), the numerator represents the number of assets which were in the i^{th} state at time j and transitioned to the (i+1)^{th} state at time j+1. The denominator represents the number of assets which were in the i^{th} state at time j.

Averaging or other processing may be performed to obtain the probabilities of a homogeneous Markov Chain model.

When sensor data are available for different groups of assets that have the same asset type (e.g., photovoltaic panel with a certain power rating range; wind turbine generator with a certain power rating range; transformer of a rating in a certain interval), but which are subjected to different operating conditions and/or ambient conditions, the transition probabilities may be updated independently for each of the groups.

FIG. 9 illustrates an output of a curve 100 that is indicative of the asset's degradation as a function of time as determined by the stochastic simulations. The curve 100 may be dependent on the time evolution of all probabilities p₁, p₂, . . . pₙ for the Markov Chain model to be in the respective 1^{st}, 2^{nd}, . . . n^{th} state, as determined by the stochastic simulations.

The various states of the Markov Chain model may be associated with a plurality of intervals 111-114. For illustration, for a health index h within interval 111, the asset may be determined to be in the state S1 in which there is no known degradation. For a health index h within interval 112, the asset may be determined to be in the state S2 in which there is no incipient degradation that does not affect the performance. For a health index h within interval 113, the asset may be determined to be in the state S3 in which there is a more severe degradation that affects the performance, but does not lead to immediate asset shutdown. For a health index h within interval 114, the asset may be determined to be in the state S4 in which the state is critical, leading to immediate asset shutdown.

Thresholds TH₁, . . . THₙ₋₁ may define the upper and lower boundaries of the intervals 111-114. Comparisons to threshold TH₁, . . . THₙ₋₁ may be used when initializing the stochastic simulations for an asset. For illustration, available sensor data for the asset may be processed into a scalar representing the asset's health index h or degradation index d=1−h, and the scalar may be compared to the thresholds TH₁, . . . THₙ₋₁ to determine how the simulations are to be initialized.

By performing stochastic simulations such as MCMC, not only the evolution of the asset's health state, but also the reliability associated with the determined evolution may be automatically determined and output.

The information on the reliability may take various forms. For illustration, an evolution of a confidence interval around the curves 80, 100 may be determined as a function of time over a prognostic time horizon. The time evolution of the confidence interval may indicate, for any time j of the prognostic time horizon, a lower boundary and an upper boundary for the critical failure probability 80 or for a health index h. The upper and lower boundaries may be determined such that at least a certain percentage (e.g., at least 70%, 80%, 90%, or 95%) of the stochastic simulations gives rise to a critical failure probability 80 or a health index h within the range between the upper and lower boundaries. Exemplary upper and lower boundaries 101, 102 indicating the time evolution of the confidence interval are shown in FIG. 7.

Alternatively or additionally, the upper and lower boundaries 101, 102 may reflect the variance in operating and/or ambient conditions to which the asset may be subjected. For illustration, the curves 100, 101, 102 may each be obtained by performing plural stochastic simulations using a Markov Chain model as explained with reference to FIG. 3, but with different sets of transitions probabilities.

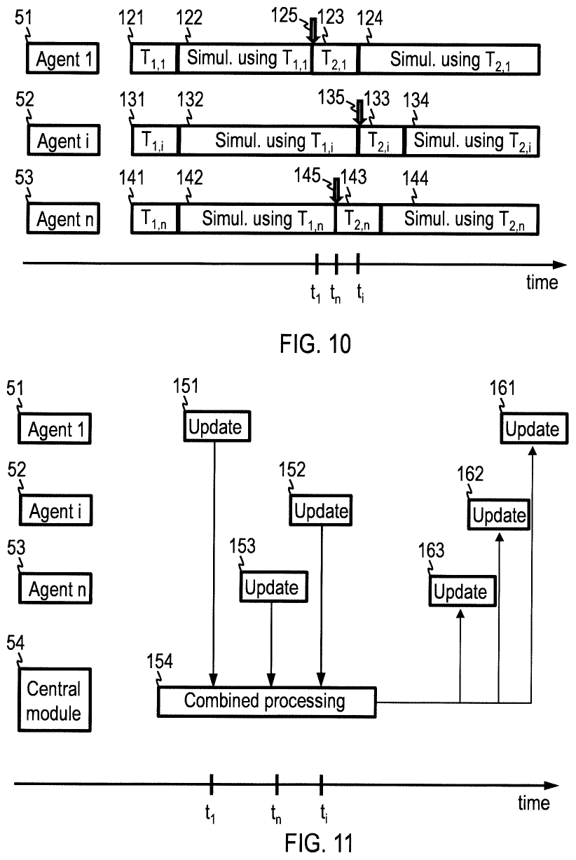

FIG. 10 is a diagram illustrating operation of a system according to an embodiment as a function of time.

Different agents 51, 52, 53 are deployed. Each of the agents 51, 52, 53 is responsible for determining a prognosis for a future evolution of an asset health state. The assets are identical or similar.

All agents 51, 52, 53 may use the same set of states S1, . . . , Sn for performing stochastic simulations. The states S1, . . . , Sn may be ordered so that severity of degradation increases from one state to the next.

The agents 51, 52, 53 may receive initial transition probabilities 121, 131, 141. The initial transition probabilities 121, 131, 141 may be determined based on a user input or based on historical data, for example using Equation (4). The initial transition probabilities 121, 131, 141 may be the same. The initial transition probabilities 121, 131, 141 may be different, for example when the operating conditions and/or ambient conditions are different for the various assets for which the agents 51, 52, 53 perform a prognostic health analysis.

After initialization, a first agent 51 performs a stochastic simulation 122 using the initial transition probabilities, which may be arranged in a transition matrix T_{1,1}. The stochastic simulation 122 may be performed during a time interval, but may extend over a prognostic time horizon which may be longer than the time interval during which the transition matrix T_{1,1} is used in the stochastic simulation.

First observation information 125 is received by the first agent 51 at a first update time t₁. The observation information 125 may include sensor data for the asset for which the first agent 51 performs the prognostic health analysis and/or transition probabilities and/or Bayesian transition probabilities determined by the other agents 52, 53 and/or the central module 54.

Receipt of the first observation information 125 triggers an update 123 of the transition matrix to T_{2,1}. Subsequently, the first agent 51 may re-run the stochastic simulation 124, at least for times later than the first update time t₁, using the updated transition matrix to T_{2,1}. An updated prognosis for the evolution of the asset health state is thereby obtained.

After initialization, an i^{th} agent 52 performs a stochastic simulation 132 using the initial transition probabilities, which may be arranged in a transition matrix T_{1,i}. The stochastic simulation 132 may be performed during a time interval, but may extend over a prognostic time horizon which may be longer than the time interval during which the transition matrix T_{1,i} is used in the stochastic simulation.

An i^{th} set of observation information 135 is received by the i^{th} agent 52 at an i^{th} update time tᵢ. The observation information 135 may include sensor data for the asset for which the i^{th} agent 52 performs the prognostic health analysis and/or transition probabilities and/or Bayesian transition probabilities determined by the other agents 51, 53 and/or the central module 54.

Receipt of the i^{th} observation information 135 triggers an update 133 of the transition matrix to T_{2,i}. Subsequently, the i^{th} agent 52 may re-run the stochastic simulation 134, at least for times later than the i^{th} update time using the updated transition matrix to T_{2,i}. An updated prognosis for the evolution of the asset health state is thereby obtained.

After initialization, an n^{th} agent 53 performs a stochastic simulation 142 using the initial transition probabilities, which may be arranged in a transition matrix T_{1,n}. The stochastic simulation 142 may be performed during a time interval, but may extend over a prognostic time horizon which may be longer than the time interval during which the transition matrix T_{1,n} is used in the stochastic simulation.

An n^{th} observation information 145 is received by the n^{th} agent 53 at an n^{th} update time tₙ. The observation information 145 may include sensor data for the asset for which the n^{th} agent 53 performs the prognostic health analysis and/or transition probabilities and/or Bayesian transition probabilities determined by the other agents 51, 52 and/or the central module 54.

Receipt of the n^{th} observation information 145 triggers an update 143 of the transition matrix to T_{2,n}. Subsequently, the n^{th} agent 53 may re-run the stochastic simulation 144, at least for times later than the n^{th} update time tₙ, using the updated transition matrix to T_{2,n}. An updated prognosis for the evolution of the asset health state is thereby obtained.

The various agents 51-53 may operate asynchronously. The updates 123, 133, 143 may be performed at different times, with the times being independent of each other. The updates 123, 133, 143 may be performed as event-triggered updated.

FIG. 11 is a diagram illustrating operation of a system according to an embodiment as a function of time.

Different agents 51, 52, 53 are deployed. Each of the agents 51, 52, 53 is responsible for determining a prognosis for a future evolution of an asset health state. The assets are identical or similar.

All agents 51, 52, 53 may use the same set of states S1, . . . , Sn for performing stochastic simulations. The states S1, . . . , Sn may be ordered so that severity of degradation increases from one state to the next.

The agents 51, 52, 53 perform stochastic simulations (not shown in FIG. 11) to determine a prognosis for a future evolution of an asset health states. Each one of the agents 51, 52, 53 may perform an update 151, 152, 153 to change the transition probabilities used by the agent in the stochastic simulation, as more reliable information on the degradation process becomes available during operation.

The central module 54 may receive information on the updates 151, 152, 153. For illustration, information on the updated transition probabilities computed by the agents 51, 52, 53 at the updates 151, 151, 152, 153 may be provided to the central module. Importance information, which may quantify the importance or reliability of an update (based, e.g., on the amount of sensor data used to generate the updated transition probabilities) may also be received by the central module 54.

The central module 54 may perform a combined processing, in order to combine the information from the updates 151, 152, 153 performed by different agents 51, 52, 53. The central module 54 may perform a probability fusion process in which the transition probabilities, as updated by some or all of the agents 51, 52, 53, are combined to compute modified transition probabilities.

The modified transition probabilities may subsequently be provided to the agents 51, 52, 53, triggering updates 161-163. The modified transition probabilities do not need to be provided synchronously to the different agents 51, 52, 53, but may be provided by the central module 54 in an asynchronous manner.

The results of the stochastic simulations may be used in various ways. A control and/or output operation may be automatically performed based on the results of the stochastic simulation, with the updated transition probabilities, or other prognostic asset health analysis.

For illustration, a RUL or PoF curve may be output. Information on a time-evolution of a confidence interval or variance may be concurrently output.

Alternatively or additionally, an operating point of the asset may be automatically adjusted by the local controller 21-23 associated with the asset.

Alternatively or additionally, inspection, maintenance, and/or replacement work may be automatically scheduled.

Alternatively or additionally, down-times for inspection, maintenance, and/or replacement work may be automatically scheduled.

Alternatively or additionally, alarms, warnings, or other output may be generated for outputting via an HMI depending on the RUL curve, PoF curve, or other prognostic asset health state evolution.

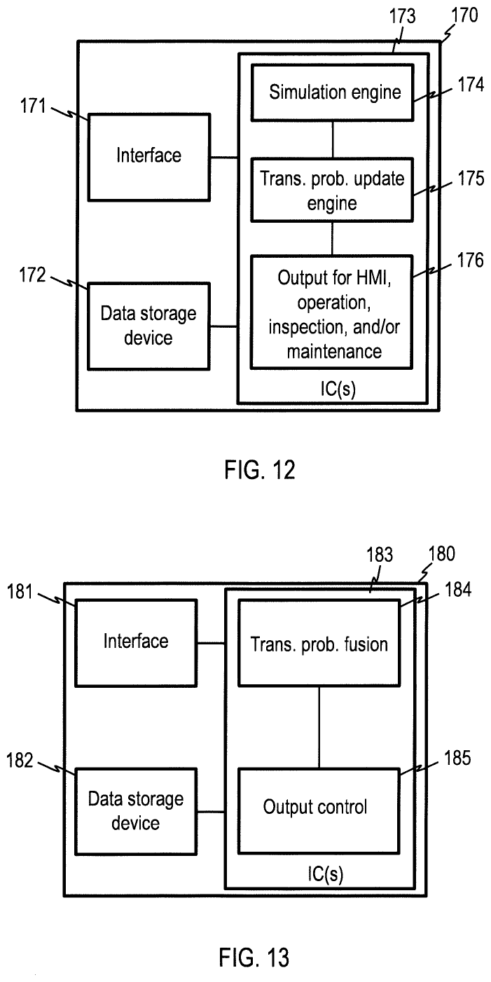

FIG. 12 is a schematic diagram of a computing system 170. The computing system 170 may comprise one or several IC(s) 173. The IC(s) may include an application specific integrated circuits (ASIC), processor, controller, field programmable gate array (FGPA), or a combination of plural such integrated circuits.

The IC(s) 173 may reside in the central system 20, one of the local controllers 21-23, the server system 24, or may be distributed across these entities. The IC(s) 173 may be operative to execute one or several of the agents 51-53.

The IC(s) 173 may be operative to execute a stochastic simulation engine 174 to simulate the time-dependent evolution of a Markov Chain model. The stochastic simulation engine 174 may be operative to perform MCMC simulations.

Initial values for the transition probabilities for the Markov Chain model used by the stochastic simulation engine 174 may be received via an interface 171 (e.g., when the IC(s) 173 are resident in one of the local controllers 21-23 and the central system 20 computes the initial transition probabilities). The transition probabilities may be updated by the IC(s) 173 based on observation information received via the interface 171 during ongoing operation of the assets. The observation information may include any one or any combination of the following:
Sensor data for the asset for which the agent executed by the IC(s) 173 determines a prognosis for a future evolution of the asset health state.
Transition probabilities p₁₂, p₂₃, . . . p_{n-1,n}, or Bayesian probability table data determined by another agent for another asset of the same or similar asset type.
Transition probabilities or Bayesian probability table data determined by a central module 54.

The IC(s) 173 may be operative to execute a transition probability update engine 175. The transition probability update engine 175 may be invoked by receipt of observation information at the interface 171, which causes the transition probability update engine 175 to update the transition probabilities used locally for performing stochastic simulations.

The IC(s) 173 may be operative to execute an output engine 176. The output engine 176 may be operative to generate output to share information on the updates performed by the transition probability update engine 175.

The output engine 176 may also generate output data or output signals for controlling an HMI and/or implementing a control operation for the asset or the system in which the asset is being used. For illustration, the output engine 176 may be operative to generate and output data to an HMI such that a RUL or PoF curve is output. The output engine 176 may be operative to generate and output data to the HMI such that information on a time-evolution of a confidence interval or variance may be concurrently output.

Alternatively or additionally, the output engine 176 may be operative to automatically adjust an operating point of the asset in response to the stochastic simulation, with transition probabilities as updated by the transition probability engine 175.

Alternatively or additionally, the output engine 176 may be operative to automatically generate and output information on inspection, maintenance, and/or replacement work.

Alternatively or additionally, the output engine 176 may be operative to automatically generate and output information on down-times for inspection, maintenance, and/or replacement work may be automatically scheduled.

Alternatively or additionally, the output engine 176 may be operative to automatically generate and output alarms, warnings, or other output may be generated for outputting via an HMI depending on the RUL or PoF curve or other prognostic asset health state evolution.

FIG. 13 is a schematic diagram of a computing system 180. The computing system 180 may comprise one or several IC(s) 183. The IC(s) may include an application specific integrated circuits (ASIC), processor, controller, field programmable gate array (FGPA), or a combination of plural such integrated circuits.

The IC(s) 183 may reside in the central system 20 or the server system 24 or may be distributed across these entities. The IC(s) 183 may be operative to execute the central module 54.

The IC(s) 183 may be operative to execute a transition probability fusion engine 184. The transition probability fusion engine 184 may combine transition probabilities as updated by several agents 51, 52, 53, optionally using importance information quantifying the relative information of the updates, to compute modified transition probabilities.

The transition probabilities as updated by several agents 51, 52, 53 may be received via an interface 181. Additional data, such as historical data used to determine the initial transition probabilities used for initializing the agents 51, 52, 53, may be stored in a data storage device 182 and may be used for determining the modified transition probabilities.

The IC(s) 183 may be operative to execute an output control 185 that output the modified transition probabilities, obtained by fusing the updates from several agents, to the agents. The output control 185 may be operative to output the modified transition probabilities to different agents 51, 52, 53 at different times. The output control 185 may be operative to output the modified transition probabilities to different agents 51, 52, 53 in an event-triggered manner, for example in response to establishment of a communication channel with the different agents 51, 52, 53.

Various effects and advantages are associated with the disclosed embodiments. The stochastic simulation executed by an agent to obtain a prognosis for the future evolution of an asset health state may be updated using dynamically arriving data from comparable industrial or power system assets. The relevant information exchange requires only a small number of parameters to be exchanged between agents and/or between a central module and the agents. Different agents can operate asynchronously.

The disclosed methods and systems may be used in association with electric power system assets, such as assets of power generation, distribution and/or transmission systems, or assets of industrial systems, without being limited thereto.

While the embodiments have been described in detail in the drawings and foregoing description, such description is to be considered illustrative or exemplary and not restrictive. Variations to the disclosed embodiments can be understood and effected by those skilled in the art and practicing the claimed embodiments, from a study of the drawings, the disclosure, and the appended claims. In the claims, the word “comprising” does not exclude other elements or steps, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A method of performing a prognostic health analysis for an asset, wherein the asset is included in a set of plural assets that are associated with a set of agents, each of the agents performing a prognostic health analysis for an associated asset of the set of assets, the method comprising the following:
determining, by an agent of the set of agents executed by at least one integrated circuit, a prognosis for a future evolution of an asset health state of an asset of the set of assets by performing a stochastic simulation, the stochastic simulation being performed using transition probabilities for transitions between states of a discrete state model;
receiving, by the agent, observation information that is a function of an observed degradation of at least one asset of the set of assets;
updating, by the agent, the prognosis, including updating the transition probabilities based on the received observation information; and
generating output based on a result of the stochastic simulation.

2. The method of claim 1, wherein the observation information is received from another agent and/or from a central module via a communication channel that is established only intermittently.

3. The method of claim 1, wherein the agent is operative to update the transition probabilities at a time that is independent of a time at which other agents update transition probabilities used by the other agents to perform stochastic simulations.

4. The method of claim 1, wherein the agent shares information on the updated transition probabilities with other agents of the set of agents in an asynchronous manner.

5. The method of claim 1, wherein the observation information is a function of sensor measurements obtained for the asset.

6. The method of claim 5, further comprising outputting, by the agent, the observation information or data derived therefrom to at least one other agent of the set of agents and/or to a central module.

7. The method of claim 1, wherein the observation information is a function of sensor measurements obtained for at least one other asset different from the asset.

8. The method of claim 1, wherein the observation information comprises modified transition probabilities and/or modified Bayesian conditional probabilities.

9. The method of claim 1, wherein the discrete state model has n states, with n being an integer greater than two, and wherein a transition matrix used in the stochastic simulation has only n−1 non-zero off-diagonal matrix elements.

10. The method of claim 1, wherein the discrete state model comprises one or more of:
at least one state in which operation of the asset is not adversely affected by a failure;
at least one state in which operation of the asset is adversely affected by a failure, but the asset continues to operate; or
a state in which the asset is inoperative due to a failure.

11. The method of claim 1, wherein the stochastic simulation is a Markov Chain Montel Carlo (MCMC) simulation.

12. The method of claim 1, wherein each of the set of agents performs a stochastic simulation to determine a prognosis for a future evolution of an asset health state of the asset associated with the respective agent, and wherein the agents independently update the transition probabilities used in the stochastic simulations.

13. The method of claim 1, further comprising:
receiving, by a central module, information on the transition probabilities updated by the agent;
determining, by the central module, modified transition probabilities; and
outputting, by the central module, the modified transition probabilities to the set of agents.

14. A computing system operative to perform a prognostic health analysis for an asset included in a set of assets, the computing system comprising at least one integrated circuit operative to execute an agent to:
determine a prognosis for a future evolution of an asset health state of the asset by performing a stochastic simulation, the stochastic simulation being performed using transition probabilities for transitions between states of a discrete state model;
receive observation information that is based on an observed degradation of at least one asset of the set of assets;
update the prognosis, including updating the transition probabilities based on the received observation information; and
generate output based on a result of the stochastic simulation.

15. The computing system of claim 14, wherein the at least one integrated circuit is operative to execute the agent to receive the observation information from another agent and/or from a central module via a communication channel that is established only intermittently.

16. An industrial or electric power system, comprising:
a set of assets; and
the computing system of claim 14 to perform a prognostic asset health analysis for an asset of the set of assets.

17. The industrial or electric power system of claim 16, wherein the computing system is a decentralized control system of the industrial or electric power system for controlling the asset.

18. The method of claim 9, wherein the observation information consists of n−1 transition probabilities.

19. The method of claim 13, wherein determining the modified transition probabilities comprises weighting received information with a weighting factor.

20. The method of claim 19, wherein the weighting factor is dependent on a reliability associated with the updated transition probabilities determined by the agent.
